(19) United States
(12) Patent Application Publication
(10) Pub. No.: US 2026/0336524 A1
(43) Pub. Date: Oct. 29, 2026

(54) ADJUSTABLE RUNNING BOARD SYSTEM

(71) Applicant: Hugo Baeza, Center Valley, PA (US)

(72) Inventor: Hugo Baeza, Center Valley, PA (US)

(21) Appl. No.: 19/193,226

(22) Filed: Apr. 29, 2025

(51) Int. Cl. B60R 3/00

(52) U.S. Cl. CPC B60R 3/002

(57) ABSTRACT

An adjustable running board system for a vehicle is disclosed. The adjustable running board system provides a plurality of bracket assemblies spaced apart along a side of the vehicle, each bracket assembly having a body bracket mechanically communicating with a chassis of the vehicle; and a step bracket adjustable connectable with the body bracket by at least three inches, wherein the step bracket provides a fork plate oriented orthogonal relative to a lateral portion of the step bracket, and wherein the fork plate is configured to fixedly attach to a running board so that a running board elevation is selectable based on a connection formed between the body bracket and the step bracket.

### BACKGROUND OF THE SUBJECT DISCLOSURE

The subject disclosure relates to vehicle accessories and, more particularly, an adjustable running board system for a vehicle.

Pickup trucks, SUVs, and other vehicles with a high ground clearance, the distance between the lowest point of the truck and the ground, are very popular vehicles throughout North America and in other parts of the world. A running board or footboard is a narrow step fitted under the side doors of such vehicles to serve as a step to the vehicle's cabin. Most pickup trucks and SUVs come with factory-installed running boards; however, some users who are of short stature, have trouble lifting their legs sufficiently, or are children trying to access a passenger seat have problems using factory-installed running boards because they are fixed and cannot be adjusted.

All factory-installed running boards are sold with fixed height brackets; and so, customers do not have a choice; they get the running board elevation (i.e., the distance between the ground and the upper surface of the running board) already installed and nothing else. Thus, if a vehicle driver or passenger is below five feet two or has trouble lifting their legs when taking a step the factory-installed running boards are too high off the ground.

Furthermore, aftermarket running boards may have a user-selected running board elevation, but that running board elevation, since it too is fixed once installed, may be problematic for other users, or when the vehicle is later being sold that running board elevation may be a dealbreaker for prospective new owners.

The specific problem with factory running boards, or aftermarket ones, is that the brackets provided are not adjustable therefore the customer cannot select the running board elevation they desire. Currently there is no adjustable bracket system for running boards in the market.

As can be seen, there is a need for an adjustable running board system so that the vehicle user gets to choose their desired running board elevation.

### SUMMARY OF THE SUBJECT DISCLOSURE

The system embodied by the subject disclosure allows the user to choose a running board elevation from a plurality of options, from a running board elevation associated with factory settings to at least three inches below, and in some embodiments establishing a running board elevation about factory settings. This adjustability may be done in increments of approximately one inch. The subject disclosure is dimensioned and adapted to fit all vehicle running boards, thereby allowing for different height adjustments regardless of vehicle.

In one aspect of the present subject disclosure, an adjustable running board system for a vehicle provides the following: a plurality of bracket assemblies spaced apart along a side of the vehicle, each bracket assembly having a body bracket mechanically communicating with a chassis of the vehicle; and a step bracket adjustable connectable with the body bracket by at least three inches, wherein the step bracket provides a fork plate oriented orthogonal relative to a lateral portion of the step bracket, and wherein the fork plate is configured to fixedly attach to a running board so that a running board elevation is selectable based on a connection formed between the body bracket and the step bracket.

In another aspect of the present subject disclosure, the adjustable running board system further includes, wherein the step bracket provides a vertical series of a plurality of step fastener holes, wherein the body bracket provides a plurality of body fastener holes that are configured to align with each of the vertical series of the plurality of step fastener holes, whereby the connection formed is selectable for setting the running board elevation, wherein a distance between each adjacent plurality of step fastener holes of the vertical series of the plurality of step fastener holes is approximately one inch so that the connection formed is selectable for setting the running board elevation at increments of approximately one inch, and wherein a total distance between an uppermost and lowermost plurality of step fastener holes of the vertical series of the plurality of step fastener holes is approximately three inches so that the connection formed is selectable for setting the running board elevation within a range of at least three inches.

In yet another aspect of the present subject disclosure, the adjustable running board system further includes a vertically oriented step connection plate providing an array of a plurality of step fastener holes, wherein each plurality of step fastener holes is spaced apart approximately one inch; a lateral portion joined, at a proximal end, to the step connection plate and extending away at an orientation approximately orthogonal to therefrom; and the fork plate extending from a distal end of the lateral portion at an orientation that is approximately orthogonal to the lateral portion and the step connection plate, wherein the drop bracket further comprises at least two fastener slots, wherein the upward-facing flange has two planes separated by an inflection point, wherein a first of the two fastener slots is on a first of the two planes, and wherein a second of the two fastener slots in on a second of the two planes.

These and other features, aspects and advantages of the present subject disclosure will become better understood with reference to the following drawings, description and claims.

### BRIEF DESCRIPTION OF THE DRAWINGS

FIG. 1 is a perspective view of an exemplary embodiment of the subject disclosure, shown in use.

FIG. 2 is a perspective view of an exemplary embodiment of the subject disclosure, shown in use but with the vehicle not shown.

FIG. 3 is an exploded perspective view of an exemplary embodiment of the subject disclosure, illustrating the attachment of running board 46 to the installed brackets 16.

FIG. 4 is an exploded perspective view of an exemplary embodiment of the subject disclosure, illustrating the attachment of a body bracket 10 to a step bracket 16 is a selectively adjustable manner as the plurality of fastener holes 14 on body connection plate 15 (or plurality of fastener holes 32 on the body connection plate 28) may be selected to align with a desire one of the vertical series of step fasteners holes 26, 24, 22, and 20 provided by the step connection plate 17 prior to forming a connection between the two brackets.

FIG. 5A is a front elevation view of an exemplary embodiment of the subject disclosure, illustrating the bracket 16 at a first position.

FIG. 5B is a front elevation view of an exemplary embodiment of the subject disclosure, illustrating the bracket 16 at a second position.

FIG. 5C is a front elevation view of an exemplary embodiment of the subject disclosure, illustrating the bracket 16 at a third position.

FIG. 5D is a front elevation view of an exemplary embodiment of the subject disclosure, illustrating the bracket 16 at a fourth position, wherein a distance between the first and second positions, a distance between the second and third positions, and the third and fourth positions may be approximately one inch. It is also understood that there may be additional plurality of step fastener holes, through making the step connection plate 17 longer.

FIG. 6 is a perspective view of an exemplary embodiment of the subject disclosure showing a connection formed between the step bracket 16 and the body bracket 10 of a bracket assembly.

FIG. 7 is an exploded perspective view of an exemplary embodiment of the subject disclosure, illustrating an option cover 44 being applied.

FIG. 8 is a perspective view of an exemplary embodiment of the subject disclosure, illustrating the option covers 44 in use.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

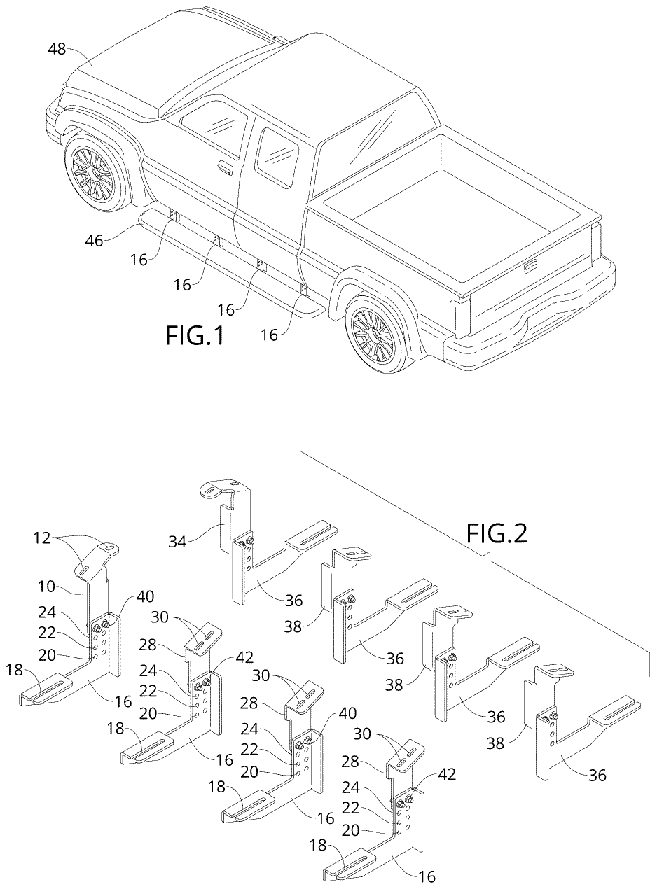

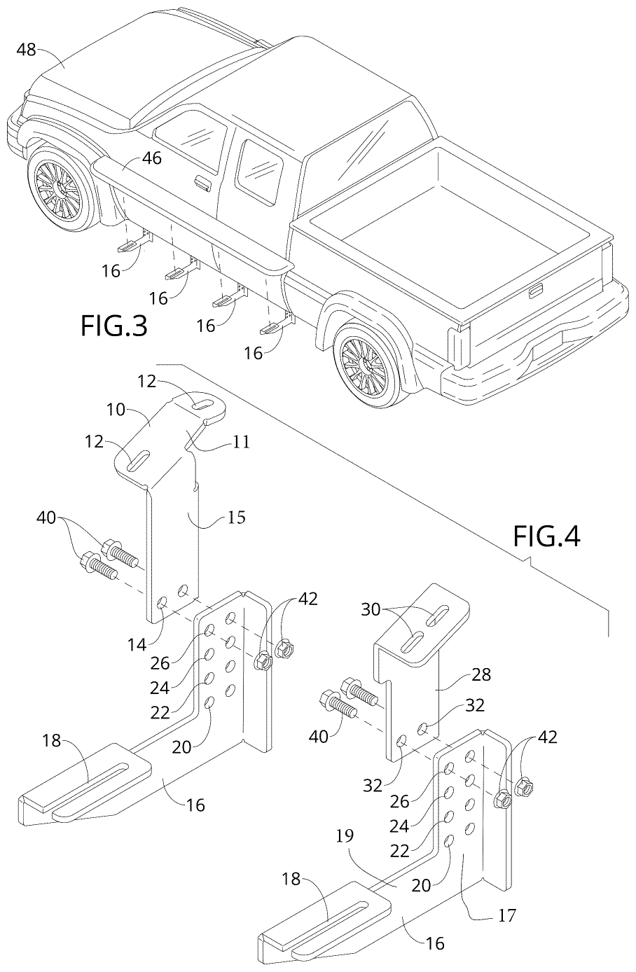

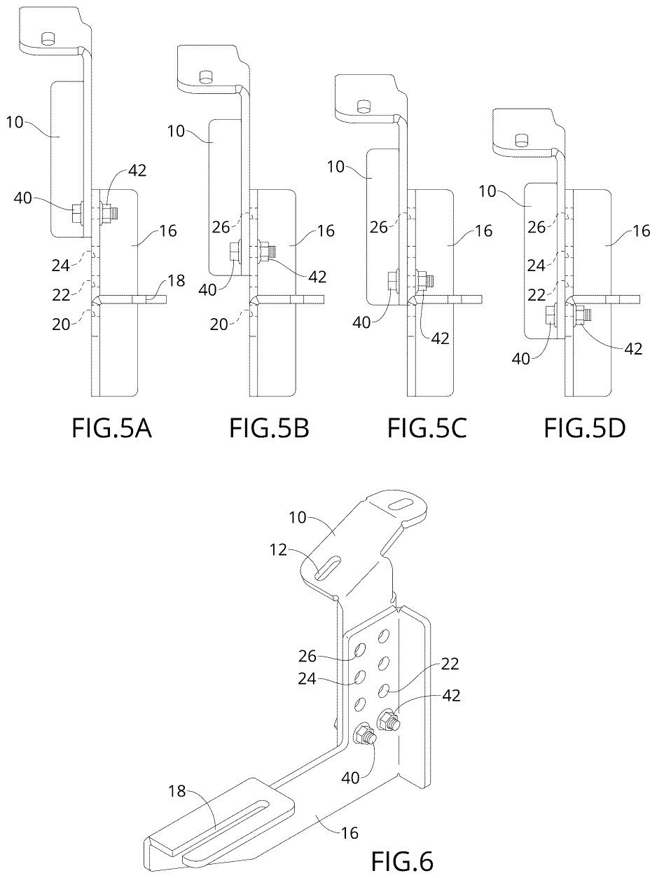

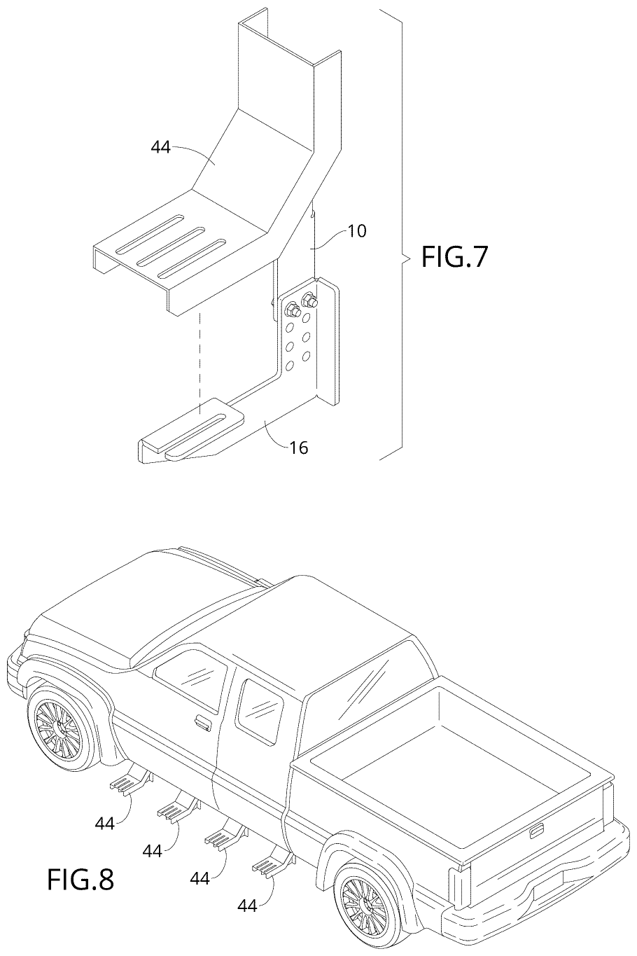

Referring now to FIGS. 1 through 8, the present provides an adjustable running board system including a plurality of side bracket assemblies that are attached to the driver and passenger side rocker panels or chassis frame so that a running board 46 may be connected to the plurality of side bracket assemblies at a desired running board elevation.

Each side bracket assembly includes a body bracket 10 and a step bracket 16, wherein the body brackets 10 mechanically communicates with the chassis/frame of the vehicle 48 and the step brackets directly but adjustably connect to the body brackets 10.

Each body bracket 10 has an upward-facing flange 11 providing at least two attachment slots 12 or 30. The upward-facing flange 11 may be planar or be defined by two planes separated by an inflection point, wherein one attachment slot 12 is along the first plane of the two planes and wherein another attachment slot 12 is along the second plane of the two planes. The upward facing attachment slots 12, 30 are configured for connecting the upward-facing flange 11 to the chassis frames by way of fasteners.

Each body bracket 10 has a body connection plate 15 or 28 depending from the upward-facing flange 11, as illustrated in FIG. 4. The body connection plate 15 or 28 may be generally planar and orientated vertically relative to the transversely oriented upward-facing flange 11. As shown in the Figures, the upward facing flange 11 may be slanted at an angle relative to the generally plomb body connection plate 15 or 28. At a distal end of the body connection plate 15 or 28, just inward of its distal edge, a plurality of body fastener holes 14 or 32 are provided.

Turning to step bracket 16, each step bracket 16 has a step connection plate 17 that is vertically oriented. The step connection plate 17 provides a series of a plurality of step fastener holes 20, 22, 24, and 26 at different elevations. Each of the plurality of step fastener holes 20, 22, 24, and 26 can be aligned with the plurality of body fastener holes 14 or 32 so that a user can select which plurality of step fastener holes 20, 22, 24, or 26 is best suited for them. Each plurality of step fastener holes 20, 22, 24, and 26 can operatively associated with the plurality of body fastener holes 14 or 32 by way of fasteners 40 and 42, thereby establishing an associated running board elevation which is discussed more in depth below.

Each step bracket 16 has a lateral portion 19 extending orthogonally from a distal end of the step connection plate 17, away from the vehicle 48 upon installation, as illustrated in FIG. 4. A proximal end of the lateral portion 19 is joined to the step connection plate 17, while a distal end of the lateral portion 19 terminates in a bracket fork 18. The bracket fork 18 may be upward facing and orthogonal relative to a longitudinal axis of the lateral portion 19. Thus, the bracket fork 18, the lateral portion 19 and the step connection plate 17 extend in the z-axis, x-axis, and the y-axis, respectively. The bracket fork 18 may have a slot extending from a distal edge thereof.

The extension of the bracket fork 18 in the z-axis direction provides depth on which to connect and critically support the running board 48. In some embodiments, a cover 44 may be provided to cover the bracket assembly, wherein the cover 44 has a fork plate, a vertical portion, and a slanted portion that interconnects the fork plate and the vertical portion. The body bracket 10 of a side bracket assemblies may have a horizontal flange 34 or 38 extending from a distal end of the connection plate 15 or 28, wherein the horizontal flange 34 or 38 are adapted to accommodate forward framing members.

Accordingly, the side bracket assemblies a can be selectively fixed so that their bracket forks 18 and thus the connected running board 46, whereby its upper surface (used to step on by users) is adapted to be adjustably set at a desired elevation off the ground—i.e., “running board elevation”—from anywhere from a factory height to more than three inches lower than factory height. Again, in some embodiments, the running board elevation may be set above the factory recommended elevation.

The spacing between two adjacent series of the plurality of step fastener holes 20, 22, 24, and 26 may be approximately one inch; thus, the running board elevation can be adjusted in increments of approximately one inch. In some embodiments, the spacing may be about half an inch or one and a half inches or more. Also, in some embodiments, the body connection plate 15 or 28 may provide the plurality of fastener holes 20, 22, 24, and 26, while the step connection plate 17 provides the one set of plurality of fastener holes that can be aligned thereto.

The subject disclosure translates the conventionally unitary running board bracket assembly into a two-piece bracket with two sets of spaced apart holes that allow a user to selectively space the lower bracket from the upper bracket, and in turn enable a user to fix the separate running board 46 at a desired height above the supporting surface of the vehicle 48.

In some embodiments a bracket fork cover 44 may be slid over each bracket fork 18 so that a running board 46 may not be necessary as a user can selectively utilize one of the covered bracket forks 18 to lift themselves up.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary. Specifically, directional terms may be defined by the Figures; for instance, ‘upward’ or ‘upper’ and other derivations thereof are directed toward the upper margin of each Figure.

It should be understood, of course, that the foregoing relates to exemplary embodiments of the subject disclosure and that modifications may be made without departing from the spirit and scope of the subject disclosure as set forth in the following claims.

What is claimed is:

1. An adjustable running board system for a vehicle, the adjustable running board system comprising:
a plurality of bracket assemblies spaced apart along a side of the vehicle, each bracket assembly comprising:
a body bracket mechanically communicating with a chassis of the vehicle; and
a step bracket adjustable connectable with the body bracket by at least three inches, wherein the step bracket provides a fork plate oriented orthogonal relative to a lateral portion of the step bracket, and wherein the fork plate is configured to fixedly attach to a running board so that a running board elevation is selectable based on a connection formed between the body bracket and the step bracket.

2. The adjustable running board system of claim 1, wherein the step bracket provides a vertical series of a plurality of step fastener holes, wherein the body bracket provides a plurality of body fastener holes that are configured to align with each of the vertical series of the plurality of step fastener holes, whereby the connection formed is selectable for setting the running board elevation.

3. The adjustable running board system of claim 2, wherein a distance between each adjacent plurality of step fastener holes of the vertical series of the plurality of step fastener holes is approximately one inch so that the connection formed is selectable for setting the running board elevation at increments of approximately one inch.

4. The adjustable running board system of claim 2, wherein a total distance between an uppermost and lowermost plurality of step fastener holes of the vertical series of the plurality of step fastener holes is approximately three inches so that the connection formed is selectable for setting the running board elevation within a range of at least three inches.

5. The adjustable running board system of claim 1, wherein the body bracket further comprises:
an upward-facing flange that is oriented transverse relative to a body connection plate that depends vertically therefrom; and
a plurality of body fastener holes just inward of a distal edge of the body connection plate.

6. The adjustable running board system of claim 5, wherein the step bracket further comprises:
a vertically oriented step connection plate providing an array of a plurality of step fastener holes, wherein each plurality of step fastener holes is spaced apart approximately one inch;
a lateral portion joined, at a proximal end, to the step connection plate and extending away at an orientation approximately orthogonal to therefrom; and
the fork plate extending from a distal end of the lateral portion at an orientation that is approximately orthogonal to the lateral portion and the step connection plate.

7. The adjustable running board system of claim 6, wherein the drop bracket further comprises at least two fastener slots.

8. The adjustable running board system of claim 7, wherein the upward-facing flange has two planes separated by an inflection point, wherein a first of the two fastener slots is on a first of the two planes, and wherein a second of the two fastener slots in on a second of the two planes.
